(19) United States
(12) Patent Application Publication
(10) Pub. No.: US 2021/0106960 A1
(43) Pub. Date: Apr. 15, 2021

(54) GAS-LIQUID MIXING CONTROL SYSTEM AND CONTROL METHOD FOR GAS-LIQUID MIXING

(71) Applicant: TRUSVAL TECHNOLOGY CO., LTD., Zhunan Township (TW)

(72) Inventors: SHIH-PAO CHIEN, Zhunan Township (TW); Cheng-Hsun Chen, Toufen City (TW); Kuan-Hung Chou, Taichung City (TW); Yi-Sen Su, Pingtung City (TW); Jhe-Wei Guo, Zhunan Township (TW)

(73) Assignee: TRUSVAL TECHNOLOGY CO., LTD., Zhunan Township (TW)

(21) Appl. No.: 17/070,066

(22) Filed: Oct. 14, 2020

(30) Foreign Application Priority Data
Oct. 15, 2019 (TW) 108137101
Aug. 17, 2020 (TW) 109127934

(51) Int. Cl. B01F 15/00; B01F 3/04; B01F 15/02

(52) U.S. Cl. CPC B01F 15/00253; B01F 15/0261; B01F 15/0037; B01F 3/04255

(57) ABSTRACT

A gas-liquid mixing control system includes a liquid supply unit, a liquid pressure regulating valve, a gas supply unit, a gas pressure regulating valve, a mixing tank, an output pipe, and a non-electric control flow regulator. The mixing tank communicates with said regulating valves; liquid and gas are mixed in the mixing tank to form mixed fluid. The first end and second end of output pipe communicate with the mixing tank and the machine respectively, making mixed fluid output from mixing tank to machine through the output pipe. The mixed fluid in first end and second end have third flow and fourth flow respectively. Said flow regulator communicates with the output pipe; the mixed fluid passing through said flow regulator has fifth flow. The first flow is not lower than at least one of the fourth and the fifth flow. Additionally, a control method for gas-liquid mixing is disclosed.

### BACKGROUND OF THE INVENTION

### 1. Technical Field

The present invention relates generally to a gas-liquid mixing system, and more particularly to a gas-liquid mixing control system and a control method for gas-liquid mixing.

### 2. Description of Related Art

In the high-tech field, gas-liquid mixed fluid with stable concentration is required to manufacture high-tech product parts (e.g., semiconductor chips, display devices, touch panels). Such gas-liquid mixed fluid with stable concentration is usually supplied to a manufacturing machine for the above-mentioned high-tech product parts at a constant pressure and flow.

Generally, an electric control device (such as a mass-flow controller, MFC) is used adjust the pressure and flow of the liquid and gas input to the mixing tank for forming the gas-liquid mixed fluid. Furthermore, another electric control device is used to adjust the pressure and flow of the gas-liquid mixed fluid output to the manufacturing machine. Therefore, conventional control method for gas-liquid mixed fluid needs electric control devices, which causes a great consumption of electric power and becomes a problem of environmental protection.

Moreover, in the above-mentioned control method, the flow of the gas-liquid mixed fluid that the electric control device can supply is subject to restriction (e.g., 6˜8 LPM). Thus, if there are several manufacturing machines that need to supply a large amount of gas-liquid mixed fluid (e.g., 10˜12 LPM), multiple control units for gas-liquid mixed fluid must be connected in parallel to fully supply the required flow of gas-liquid mixed fluid. However, connecting multiple control units in parallel occupies additional space in the plant and consumes a large amount of electric power, which increases the manufacturing cost of the above-mentioned high-tech product parts.

On the other hand, if the flow of the gas-liquid mixed fluid required by the manufacturing machine is low (e.g., 2˜4 LPM), which exceeds the control capability of the electric control devices, concentration ratio and other related parameters of the gas-liquid mixed fluid will be imbalanced, so that the requirements of the above-mentioned manufacturing machine will not be satisfied.

It is known from the above that there are many problems in the existing gas-liquid mixing control system and control method, which still needs to be improved, BRIEF SUMMARY OF THE INVENTION

In view of the above, the primary objective of the present invention is to provide a gas-liquid mixing control system and a control method for gas-liquid mixing, which regulates the output flow of gas-liquid mixed fluid in a non-electric way and can supply flow in a large range (e.g., 2˜16 LPM). In this way, a single gas-liquid mixing control system can meet the flow requirements for both low-flow (2˜4 LPM) and high-flow (10˜14 LPM). Furthermore, the gas-liquid mixing control system and control method in the present invention work in a non-electric way, which can avoid the consumption of power resources and meet the environmental protection requirements of the new-type manufacturing industry.

The present invention provides a gas-liquid mixing control system including a liquid supply unit, a liquid pressure regulating valve, a gas supply unit, a gas pressure regulating valve, a mixing tank, an output pipe, and a non-electric control flow regulator. The liquid supply unit is provided for providing a liquid with a first constant pressure and a first flow; the liquid pressure regulating valve communicates with the liquid supply unit for keeping the liquid at a first constant pressure and a first flow; the gas supply unit is provided for providing a gas with a second constant pressure and a second flow; the gas pressure regulating valve communicates with the gas supply unit for keeping the gas at a second constant pressure and a second flow, wherein the second constant pressure of the gas is higher than the first constant pressure of the liquid; the mixing tank communicates with the liquid pressure regulating valve and the gas pressure regulating valve, wherein the liquid pressure regulating valve is installed between the liquid supply unit and the mixing tank, and the gas pressure regulating valve is installed between the gas supply unit and the mixing tank. The liquid pressure regulating valve and the liquid supply unit input the liquid to the mixing tank with the first constant pressure and the first flow, and the gas pressure regulating valve and the gas supply unit input the gas to the mixing tank with the second constant pressure and the second flow, wherein the liquid and the gas are mixed in the mixing tank to form a mixed fluid; a first end of the output pipe communicates with the mixing tank, wherein the pressure of the mixed fluid in the mixing tank and the output pipe are the same; and a second end of the output pipe communicates with at least one machine, so that the mixed fluid is output from the mixing tank to the at least one machine through the output pipe; the mixed fluid in the first end is provided with a third flow, and the mixed fluid in the second end is provided with a fourth flow; the non-electric control flow regulator communicates with the output pipe, wherein the mixed fluid passing through the non-electric control flow regulator is provided with a fifth flow; wherein the first flow is greater than or equal to at least one of the fourth flow and the fifth flow.

Another objective of the present invention is to provide a control method for gas-liquid mixing, including the steps of:

providing a liquid with a first constant pressure and a first flow into a mixing tank; providing a gas with a second constant pressure and a second flow into the mixing tank, wherein the second constant pressure of the gas is higher than the first constant pressure of the liquid;

mixing the liquid and the gas in the mixing tank to form a mixed fluid; and outputting the mixed fluid from the mixing tank to at least one machine through an output pipe, wherein the pressure of the mixed fluid in the mixing tank and the output pipe are the same; a first end of the output pipe communicates with the mixing tank, and a second end of the output pipe communicates with the at least one machine; the mixed fluid in the first end is provided with a third flow, and the mixed fluid in the second end is provided with a fourth flow; the output pipe communicates with a non-electric control flow regulator, and the mixed fluid passing through the non-electric control flow regulator is provided with a fifth flow;

wherein the first flow is greater than or equal to at least one of the fourth flow and the fifth flow.

The effects of the present invention are that, the gas-liquid mixing control system and control method use the non-electric control flow regulator to regulate the output flow of the gas-liquid mixed fluid, and can supply flow in a large range (e.g., 2˜16 LPM). In this way, a single gas-liquid mixing control system can meet the flow requirements for both low-flow (2˜4 LPM) and high-flow (10˜14 LPM). Furthermore, the gas-liquid mixing control system and control method in the present invention work in a non-electric way, which can avoid the consumption of power resources and meet the environmental protection requirements of the new-type manufacturing industry.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic diagram of the gas-liquid mixing control system of the preferred embodiment of the present invention;

FIG. 2 is a time-flow graph of liquid input and mixed fluid output in the preferred embodiment;

FIG. 3 is a flow-pressure graph of mixed fluid in the conventional gas-liquid mixing system;

FIG. 4 is a chart of usage amount by the device (machine) and the total flow or the pressure of the mixed fluid in the preferred embodiment, which compares systems with and without the back pressure valve; and

FIG. 5 is a flow chart of the control method for gas-liquid mixing of the preferred embodiment.

### DETAILED DESCRIPTION OF THE INVENTION

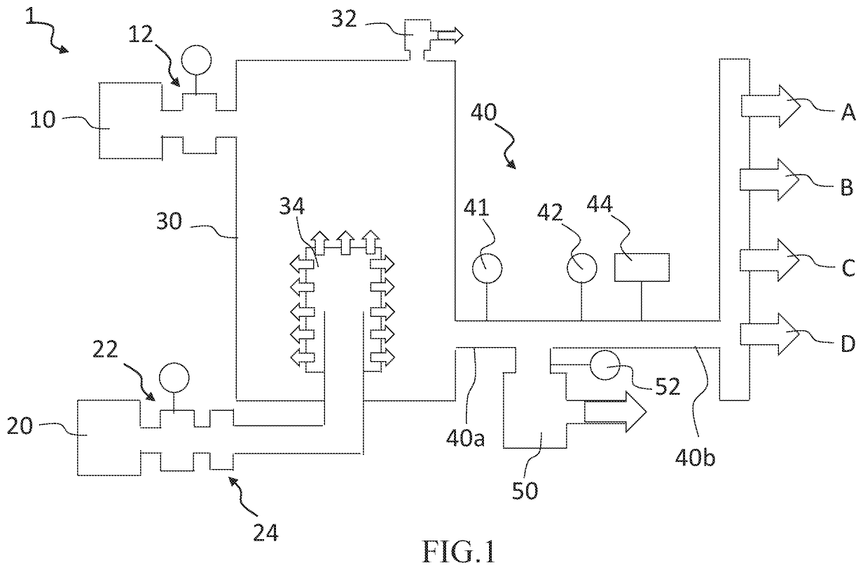

FIG. 1 is a schematic diagram of a gas-liquid mixing control system 1 of a preferred embodiment of the present invention. The gas-liquid mixing control system 1 can be used to mix water and carbon dioxide to form carbon dioxide water fluid, but this is not a limitation of the present invention. Chemical liquid dilution system 1 includes a liquid supply unit 10, a gas supply unit 20, a mixing tank 30, an output pipe 40, and a non-electric control flow regulator 50.

In this embodiment, the liquid supply unit 10 is used to provide a liquid with a first constant pressure and a first flow (such as water), and the gas supply unit 20 is used to provide a gas with a second constant pressure and a second flow (such as carbon dioxide).

In FIG. 1. the mixing tank 30 is connected to the liquid supply unit 10 and the gas supply unit 20. Moreover, the liquid supply unit 10 inputs the liquid into the mixing tank 30 with the first constant pressure and the first flow. A liquid pressure regulating valve 12 can be provided between the liquid supply unit 10 and the mixing tank 30 for controlling the supply pressure of the liquid, or alternatively, the liquid supply unit 10 directly supplies the liquid at the required fixed pressure. The gas supply unit 20 inputs the gas into the mixing tank 30 with the second constant pressure and the second flow. A gas pressure regulating valve 22 can be provided between the gas supply unit 20 and the mixing tank 30 for controlling the supply pressure of the gas, or alternatively, the supply side directly supplies the gas at the required fixed pressure. Furthermore, a gas flowmeter 24 is provided between the gas supply unit 20 and the mixing tank 30 for measuring and controlling the gas flow into the mixing tank 30, and the liquid and the gas are mixed in the mixing tank 30 to form a mixed fluid. In this embodiment, the gas flowmeter 24 can be a float flowmeter, but this is not a limitation of the present invention. In this embodiment, the mixing tank 30 communicates with the liquid pressure regulating valve 12 and the gas pressure regulating valve 22. The liquid pressure regulating valve 12 control the liquid to be input into the mixing tank 30 at the first constant pressure and the first flow, and the gas pressure regulating valve 22 control the gas to be input into the mixing tank 30 at the second constant pressure and the second flow.

In this embodiment, the liquid pressure regulating valve 12 includes a mechanical pressure flow meter for testing the pressure and the flow of the liquid output from the liquid supply unit 10 and the input first flow F1 of the liquid; the gas supply unit 20 also includes a mechanical pressure flow meter for testing the pressure and the flow of the gas output from the gas supply unit 20. In addition, the liquid supply flow is at L/min level, while the gas supply flow is at mL/min level, wherein the difference is more than a thousand times. Moreover, the gas will be dissolved in the liquid, and only the excess part of the gas will be discharged by a venting device 32, so that a third flow F3 of the mixed fluid in the mixing tank 30 and a first end 40a of the output pipe 40 is almost the same as the first flow F1 of the inputting liquid. In other words, the first flow F1 is greater than or equal to 1000 times the second flow, and thus the third flow F3 of the mixed fluid which is mixed by the liquid and the gas is approximately equal to the first flow F1. In this embodiment, the second constant pressure of the gas is greater than the first constant pressure of the liquid.

In FIG. 1, the first end 40a of the output pipe 40 communicates with the mixing tank 30, while its second end 40b communicates with at least one machine A, B, C, D, so that the mixed fluid is output from the mixing tank 30 into the machine A, B, C, D through the output pipe 40. In this embodiment, the pressure of the mixed fluid in the mixing tank 30 and the output pipe 40 are the same. Furthermore, the flow of the mixed fluid in the first end 40a of the output pipe 40 is the third flow F3, while the flow of the mixed fluid in the second end 40b of the output pipe 40 is fourth flow F4 which is regulated by valves of the machine A, B, C, D. When the mixing tank 30 maintains a constant pressure inside, and the flow through the nozzles of the same size will be the same, the more the valves of machine A, B, C, D are opened, the higher the value of the fourth flow F4 is. In this embodiment, the fourth flow F4 in the second end 40b of the output pipe 40 meets a requirement of the at least one machine A, B, C, D to the mixed fluid.

In FIG. 1, the non-electric control flow regulator 50 communicates with the output pipe 40, and the flow of the mixed fluid passing through the non-electric control flow regulator 50 is fifth flow F5. In this embodiment, the first flow F1 is greater than or equal to the third flow F3, and the first flow F1 is greater than or equal to at least one of the fourth flow F4 and the fifth flow F5. In practice, the range of the first flow F1 can be 0˜16 LPM; also, the range of the third flow F3, the fourth flow F4, and the fifth flow F5 can be 0˜16 LPM as well.

In the embodiment of the present invention, the first flow F1 is greater than the sum of the fourth flow F4 and the fifth flow F5. That is, if F1=16 LPM, F4=10 LPM, and F5=5.5 LPM.

In the embodiment of the present invention, the first flow F1 is equal to the sum of the fourth flow F4 and the fifth flow F5. That is, if F1=16 LPM, F4=6 LPM, and F5=10 LPM.

In the embodiment of the present invention, the first flow F1 is a fixed value which is preset to 16 LPM (but this is not a limitation, and the value can be adjusted according to actual needs). In addition, if the first flow F1 is greater than the fourth flow F4, the difference between the first flow F1 and the fourth flow F4 is discharged by the non-electric control flow regulator 50 which can be a mechanical valve, such as a back pressure valve. The principle of operation of the back pressure valve 50 is that, the fluid enters the back pressure valve 50 from an inlet and is blocked by a diaphragm, and then exerts an upward pressure on the diaphragm. When the pressure is high enough, a spring is compressed, and the fluid pushes up the diaphragm to form a channel, so that the fluid can flow out from an outlet of the back pressure valve 50. If the fluid pressure is not high enough, which forms a built-up pressure, the fluid pressure in the inlet will rise; until the pressure rises to the preset pressure of the back pressure valve, the fluid will push up the diaphragm to form a passage for being discharged. The pressure of the fluid changes when the fluid flow changes, which then changes the opening size of the diaphragm, so as to automatically regulate the fifth flow FS.

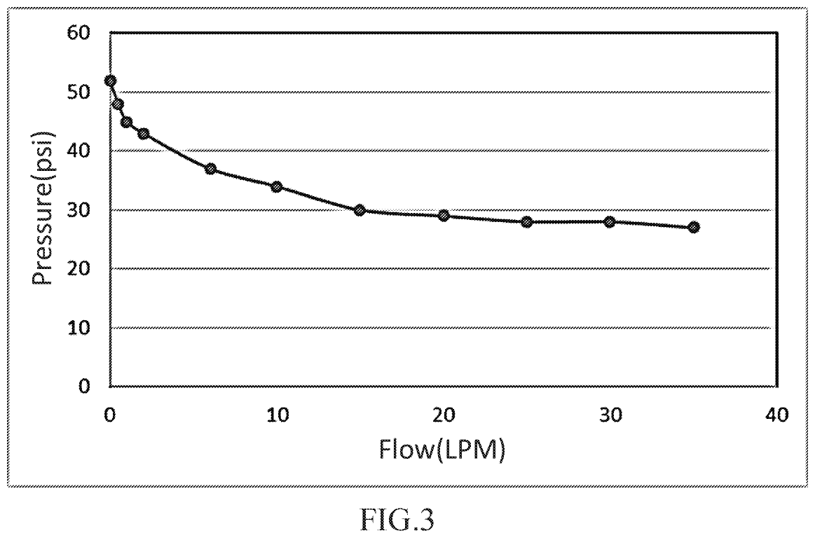

When the pressure of the pipes or the device container are unstable, the back pressure valve can maintain the required pressure of the pipes. In other words, in the gas-liquid mixing control system, stabilizing the pressure of the mixing tank is a key factor to control the concentration of the mixed fluid. In the general factory water supply system, the relationship between flow and the pressure is shown in FIG. 3. The change in pressure is large if the flow is between 0˜15 LPM; if the flow is greater than 15 LPM, the change in pressure relative to the flow is less. However, conventional gas-liquid mixing devices will not only use flow above 15 LPM, wherein the change in usage flow by most rear-end machines varies, and most of the flow changes from 1 LPM to 20 LPM or more. If the flow is constantly changing, the pressure of the mixing tank and the pipes cannot remain stable. Therefore, the concentration for gas-liquid mixing is constantly changing, which is unable to provide a mixed fluid with stable concentration to the target.

In the preferred embodiment, the back pressure valve (i.e., the non-electric control flow regulator 50) functions in the gas-liquid mixing control system 1. When the flow required by the rear-end machine A, B, C, D becomes smaller, the pressure inside the mixing tank 30 and the output pipe 40 rise; when the pressure exceeds the preset pressure of the back pressure valve 50, the back pressure valve 50 starts to relieve pressure, wherein the mixed fluid is discharged from the back pressure valve 50 which controls the discharged flow of the mixed fluid to maintain the internal pressure of the mixing tank 30 and the output pipe 40. On the other hand, when the flow required by the rear-end machine A, B, C, D becomes higher, the pressure inside the mixing tank 30 and the output pipe 40 decrease; when the pressure is lower than the preset pressure of the back pressure valve 50, the opening size of the back pressure valve 50 becomes smaller, so that the flow of the mixed fluid discharged from the back pressure valve 50 decreases, which gradually increases the flow of the mixed fluid supplied to the rear-end machine A, B, C, D. Even more, when the flow required by the rear-end machine A, B, C, D becomes higher, and the pressure inside the mixing tank 30 and the output pipe 40 decrease to below the preset pressure of the back pressure valve 50, the back pressure valve 50 closes, so that the flow of the mixed fluid discharged from the back pressure valve 50 becomes 0, and total flow of the mixed fluid is supplied to the rear-end machine A, B, C, D. The abovementioned gas-liquid mixing control system and the control method can stable the internal pressure of the mixing tank 30 and the output pipe 40 to firmly maintain the mixing ratio and concentration of the gas and the liquid, and to supply the rear-end machine A, B, C, D with stable use flow.

In the preferred embodiment, the difference between the first flow F1 and the fourth flow F4 is greater than or equal to the fifth flow F5. For example, if only the machine A requires mixed fluid, the fourth flow F4 may be only 2 LPM; when the flow of the liquid input to the mixing tank is 16 LPM, the third flow F3 output from the mixing tank 30 is 16 LPM, and the extra 14 LPM is discharged by the non-electric control flow regulator 50. Additionally, if all the machines A, B, C, D require mixed fluid, the fourth flow F4 is 12 LPM; when the flow of the liquid input to the mixing tank is 16 LPM, the third flow F3 output from the mixing tank 30 is 16 LPM, and the extra 4 LPM is discharged by the non-electric control flow regulator 50.

In FIG. 1, the gas flowmeter 24 is provided to measure and regulate the flow of the gas input to the mixing tank 30, which makes the mixed fluid be within a preset range of conductivity. The output pipe 40 includes a conductivity meter 44 located between the first end 40a and the second end 40b for detecting the conductivity value of the mixed fluid. Moreover, the output pipe 40 includes a mechanical pressure flow meter 41 located between the first end 40a and the second end 40b for measuring the pressure of the mixed fluid and the third flow F3. The output pipe 40 includes another mechanical pressure flow meter 42 located between the first end 40a and the second end 40b for measuring the pressure of the mixed fluid and the fourth flow F4. In the preferred embodiment, the non-electric control flow regulator 50 also includes a mechanical pressure flow meter 52 installed on a connecting pipe between the non-electric control flow regulator 50 and the output pipe 40 for measuring the pressure of the mixed fluid and the fourth flow F4. In the preferred embodiment, the back pressure valve 50 has a preset threshold. When the machines A, B, C, D close, the fourth flow F4 of the mixed fluid in the second end 40b of the output pipe 40 is 0; at this time, the internal pressure of the mixing tank 30 is fixed, so the pressure of the mixed fluid in the output pipe 40 and the mixing tank 30 are higher than the preset threshold of the back pressure valve 50, which makes the mixed fluid with the fifth flow F5 be discharged from the back pressure valve 50. If at least one of the machines A, B, C, D is opened, the flow of the mixed fluid in the second end 40b of the output pipe 40 is fourth flow F4, and the pressure of the mixed fluid in the mixing tank 30 is dispersed to the second end 40b of the output pipe 40 and the back pressure valve 50. Meanwhile, if the mechanical pressure flow meter 52 installed on the connecting pipe between the back pressure valve 50 and the output pipe 40 determines that the pressure of the mixed fluid flowing to the back pressure valve 50 is higher than or equal to the preset threshold of the back pressure valve 50, the mixed fluid will be discharged from the back pressure valve 50, and the fifth flow F5 is reduced. However, if the mechanical pressure flow meter 52 installed on the connecting pipe between the back pressure valve 50 and the output pipe 40 determines that the pressure of the mixed fluid flowing to the back pressure valve 50 is lower than the preset threshold of the back pressure valve 50, the fifth flow of the mixed fluid will be 0, and the mixed fluid cannot be discharged from the back pressure valve 50.

In FIG. 1, the mixing tank 30 includes the venting device 32 provided on the top of the mixing tank 30 for discharging the extra part of the gas from the mixing tank 30. In the preferred embodiment, the venting device 32 can discharge a part (the extra) of the liquid out of the mixing tank 30.

In FIG. 1, the mixing tank 30 includes a gas dispersion device 34 located in the mixing tank 30 for dispersing the gas into the liquid to form the mixed fluid.

In the preferred embodiment, the non-electric control flow regulator 50 is a mechanical valve which doesn't use electric power. That is, the mechanical valve needs no electric power for control, which can avoid the consumption of power resources and meet the environmental protection requirements of the new-type manufacturing industry.

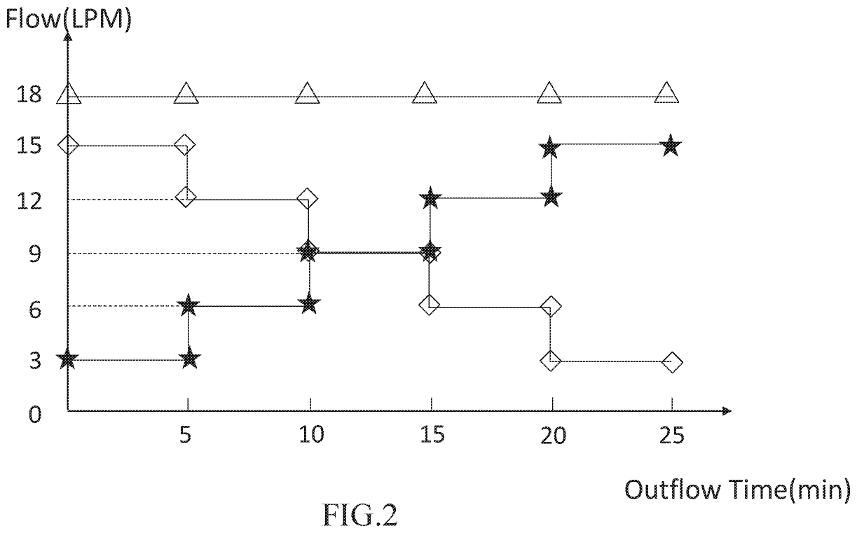

In FIG. 2, the first flow F1 is equal to the third flow F3. The third flow F3(Δ) is a fixed value which is preset to 16 LPM (but this is not a limitation, and the value can be adjusted according to actual needs). In addition, if the third flow F3(Δ) is greater than the fourth flow F4(*), the difference between the third flow F3(Δ) and the fourth flow F4(*) is discharged by the non-electric control flow regulator 50. In this embodiment, the difference between the third flow F3(Δ) and the fourth flow F4(*) is equal to the fifth flow F5(⋄). For example, if only the machine A requires mixed fluid, the fourth flow F4(*) may be 3 LPM, and the third flow F3(Δ) output by the mixing tank 30 is kept at 18 LPM, while the extra 15 LPM is discharged by the non-electric control flow regulator 50, which is the fifth flow F5(⋄). Moreover, if all the machines A, B, C, D are continuously opened and require mixed fluid, the fourth flow F4(*) will be 15 LPM, and the third flow F3(Δ) output by the mixing tank 30 is kept at 18 LPM, while the extra 3 LPM is discharged by the non-electric control flow regulator 50, which is the fifth flow F5(⋄). Besides, if all machines don't need to supply mixed fluid, the fourth flow F4(*) is 0 LPM, and the third flow F3(Δ) output by the mixing tank 30 is kept at 18 LPM; then, all the 18 LPM flow will be discharged by the non-electric control flow regulator 50, i.e., the fifth flow F5(⋄). From the above, the gas-liquid mixing control system of the present invention can supply flow with a large range (e.g., 0˜18 LPM), so that the flow requirements of the gas-liquid mixed fluid in both low-flow (0˜4 LPM) and high-flow (10˜18 LPM) can be satisfied by a single gas-liquid mixing control system.

As illustrated in FIG. 3, the flow-pressure graph of mixed fluid in the conventional gas-liquid mixing system, since the mixed fluid is continuously produced in the mixing tank, the internal pressure of the mixing tank will be accumulated; when the mixed fluid flows out from the mixing tank, the internal pressure of the mixing tank will decrease significantly and be stabilized as the flow of the mixed fluid increases. It's known from the FIG. 3 that if the flow of the mixed fluid is lower than 10 LPM, the pressure of the mixing tank 30 will between 55 psi and 35 psi; and if the flow of the mixed fluid is higher than or equal to 10 LPM, the pressure of the mixing tank will between 35 psi and 25 psi. Thus, generally, under the condition of a large flow of the mixed fluid, the conventional gas-liquid mixing system has a relatively stable pressure performance, and the concentration of the supplied mixed fluid will be relatively stable; however, under the condition of a low flow of the mixed fluid, due to the drastic changes in the pressure of the mixing tank, the concentration of the mixed fluid is relatively unstable, which adversely affects the yield of semiconductor products.

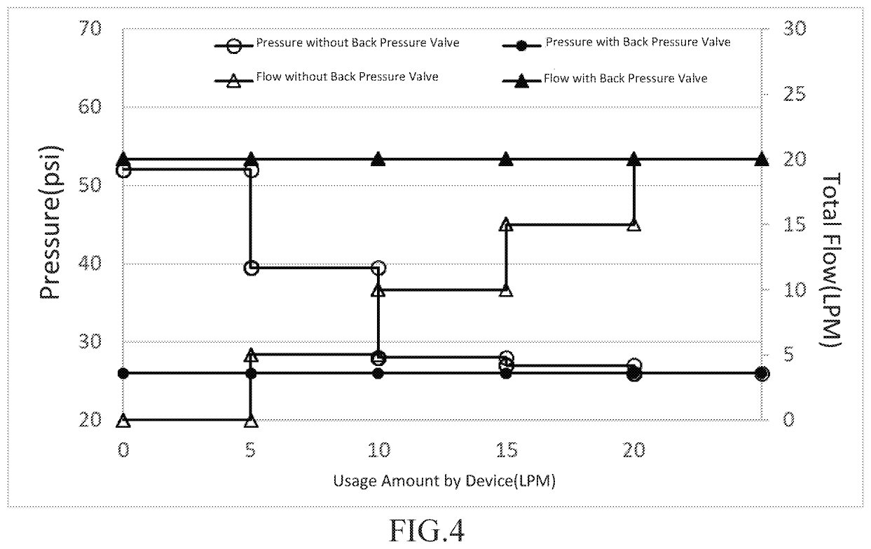

As shown in FIG. 4, the chart of usage amount by the device (machine) of the preferred embodiment of the present invention and the total flow or the pressure of the mixed fluid, the systems with and without the back pressure valve are compared. In detail, the horizontal axis in FIG. 4 represents the usage amount of the mixed fluid by the device (machine), the left vertical axis represents the pressure value of the mixing tank, and the right vertical axis is the total flow of the mixed fluid. Furthermore, the pressure of the mixing tank and the flow of the mixed fluid in the conventional gas-liquid mixing system without the back pressure valve are respectively represented by “o” and “A”; while the pressure of the mixing tank 30 and the flow of the mixed fluid in the gas-liquid mixing control system of the preferred embodiment with the back pressure valve are respectively represented by “●” and “▴”. As depicted in FIG. 4, it is known that the pressure of the mixing tank in the conventional gas-liquid mixing system without the back pressure valve will decrease as the usage amount of the mixed fluid by the device (machine) increases, and the total flow of the mixed fluid will be increased as the usage amount of the mixed fluid by the device (machine) increases. In contrast to the conventional gas-liquid mixing system without the back pressure valve, in the preferred embodiment of the present invention, since the mixed fluid is continuously produced from the mixing tank 30, the internal pressure of the mixing tank 30 will be accumulated; if the accumulated internal pressure of the mixing tank 30 exceeds an opening pressure value of the non-electric control flow regulator 50 (the back pressure valve), the non-electric control flow regulator 50 (the back pressure valve) will open so that the mixed fluid will be discharged from the mixing tank. Meanwhile, the internal pressure of the mixing tank 30 is kept within a preset pressure range; additionally, when the flow of the mixed fluid increases, the internal pressure of the mixing tank 30 is kept within the preset pressure range. In other words, in the gas-liquid mixing control system with the back pressure valve provided by the preferred embodiment of the present invention, the pressure of the mixing tank 30 is kept constant, which will not change as the usage amount of the mixed fluid by the device (machine) increases. Furthermore, the total flow of the mixed fluid is regulated by the back pressure valve and is kept constant, which will not change as the usage amount of the mixed fluid by the device (machine) increases.

As described above, the gas-liquid mixing control system of the preferred embodiment uses the back pressure valve to improve the past adverse effects on semiconductor product yield, which caused from the unstable concentration of the mixed fluid due to the dramatic pressure changes in the mixing tank under low flow condition. Compared with the conventional gas-liquid mixing system, the gas-liquid mixing control system of the present invention can maintain a constant pressure value of the mixing tank 30 and a fixed total flow of the mixed fluid regardless of the usage amount of the mixed fluid by the device (machine) in order to maintain the high stability of the mixed fluid concentration, and thereby to significantly improve the yield of semiconductor products. In the preferred embodiment, under the condition of a low flow of the mixed fluid (e.g., the usage amount by the device (machine) is below 20 LPM), the gas-liquid mixing control system can maintain a constant pressure value of the mixing tank 30 and a fixed total flow of the mixed fluid, so as to maintain the high stability of the mixed fluid concentration, and thus to significantly improve the yield of semiconductor products as shown in FIG. 4.

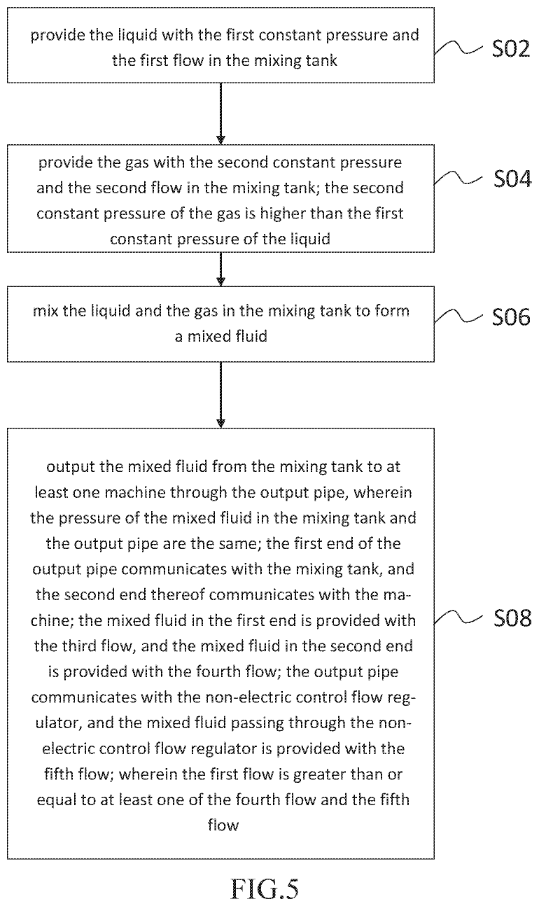

As depicted in FIG. 1 and FIG. 5, the control method for gas-liquid mixing includes the following steps.

Step S02: provide the liquid with the first constant pressure and the first flow F1 in the mixing tank;

Step S04: provide the gas with the second constant pressure and the second flow in the mixing tank, wherein the second constant pressure of the gas is higher than the first constant pressure of the liquid;

Step S06: mix the liquid and the gas in the mixing tank 30 to form a mixed fluid;

Step S08: output the mixed fluid from the mixing tank 30 to at least one machine A, B, C, D through the output pipe 40, wherein the pressure of the mixed fluid in the mixing tank 30 and the output pipe 40 are the same; the first end 40a of the output pipe 40 communicates with the mixing tank 30, and the second end 40b thereof communicates with the machine A, B, C, D; the mixed fluid in the first end 40a of the output pipe 40 is provided with the third flow F3, and the mixed fluid in the second end 40b of the output pipe 40 is provided with the fourth flow F4; the output pipe 40 communicates with the non-electric control flow regulator 50, and the mixed fluid passing through the non-electric control flow regulator 50 is provided with the fifth flow F5, wherein the third flow F3 is greater than or equal to the fourth flow F4 and the fifth flow F5.

In the preferred embodiment, the first flow F1 is greater than or equal to 1000 times the second flow, and the third flow F3 is approximately equal to the first flow F1. Moreover, the first flow F1 is greater than the sum of the fourth flow F4 and the fifth flow F5. In another preferred embodiment, the first flow F1 is equal to the sum of the fourth flow F4 and the fifth flow F5.

In the embodiment of the present invention, the first flow F1 is equal to the third flow F3 which is a fixed value; when the third flow F3 is greater than the fourth flow F4, the difference between the third flow F3 and the fourth flow F4 is discharged by the non-electric control flow regulator 50. In the embodiment, the difference between the third flow F3 and the fourth flow F4 is equal to the fifth flow F5.

In the embodiment of the present invention, the mixing tank 30 includes a gas dispersion device 34 located in the mixing tank 30 for dispersing the gas into the liquid to form the mixed fluid. The non-electric control flow regulator 50 is a mechanical valve which can be a back pressure valve with a purely physical structure that does not require electric power. That is, the mechanical valve needs no electric power for control, which can avoid the consumption of power resources and meet the environmental protection requirements of the new-type manufacturing industry.

With the design in the embodiment of the present invention, the gas-liquid mixing control system and control method use the non-electric control flow regulator to control the output flow of the gas-liquid mixed fluid, and can supply flow in a large range (e.g., 2˜16 LPM). In this way, a single gas-liquid mixing control system can meet the flow requirements of the gas-liquid mixed fluid for both low-flow (2˜4 LPM) and high-flow (10˜14 LPM). Furthermore, the gas-liquid mixing control system and control method in the present invention work in a non-electric way, which can avoid the consumption of power resources and meet the environmental protection requirements of the new-type manufacturing industry.

The embodiments described above are only preferred embodiments of the present invention. All equivalent structures and methods which employ the concepts disclosed in this specification and the appended claims should fall within the scope of the present invention.

What is claimed is:

1. A gas-liquid mixing control system, comprising:
a liquid supply unit for providing a liquid;
a liquid pressure regulating valve which communicates with the liquid supply unit for keeping the liquid at a first constant pressure and a first flow;
a gas supply unit for providing a gas;
a gas pressure regulating valve which communicates with the gas supply unit for keeping the gas at a second constant pressure and a second flow, wherein the second constant pressure of the gas is higher than the first constant pressure of the liquid;
a mixing tank communicating with the liquid pressure regulating valve and the gas pressure regulating valve, wherein the liquid pressure regulating valve is installed between the liquid supply unit and the mixing tank, and the gas pressure regulating valve is installed between the gas supply unit and the mixing tank; the liquid pressure regulating valve inputs the liquid to the mixing tank with the first constant pressure and the first flow, and the gas pressure regulating valve inputs the gas to the mixing tank with the second constant pressure and the second flow, wherein the liquid and the gas are mixed in the mixing tank to form a mixed fluid;
an output pipe which has a first end communicating with the mixing tank, wherein the pressure of the mixed fluid in the mixing tank and the output pipe are the same; the output pipe has a second end communicating with at least one machine, the mixed fluid is output from the mixing tank to the at least one machine through the output pipe; the mixed fluid in the first end is provided with a third flow, and the mixed fluid in the second end is provided with a fourth flow; and
a non-electric control flow regulator which communicates with the output pipe, wherein the mixed fluid passing through the non-electric control flow regulator is provided with a fifth flow;
wherein the first flow is greater than or equal to at least one of the fourth flow and the fifth flow.

2. The gas-liquid mixing control system of claim 1, wherein the third flow is a fixed value; if the third flow is greater than the fourth flow, a difference between the third flow and the fourth flow is discharged by the non-electric control flow regulator.

3. The gas-liquid mixing control system of claim 2, wherein the difference between the third flow and the fourth flow is equal to the fifth flow.

4. The gas-liquid mixing control system of claim 1, further comprising a gas flowmeter provided between the gas supply unit and the mixing tank; the gas flowmeter communicates with the gas supply unit and the mixing tank for measuring and controlling the second flow of the gas, which makes the mixed fluid be within a preset range of conductivity.

5. The gas-liquid mixing control system of claim 4, wherein the output pipe comprises a conductivity meter provided between the first end and the second end for detecting a conductivity value of the mixed fluid.

6. The gas-liquid mixing control system of claim 1, wherein the mixing tank comprises a venting device provided on a top of the mixing tank for discharging an extra part of the gas from the mixing tank.

7. The gas-liquid mixing control system of claim 1, wherein the first flow is greater than or equal to 1000 times the second flow; the third flow is approximately equal to the first flow.

8. The gas-liquid mixing control system of claim 1, wherein the mixing tank comprises a gas dispersion device located within the mixing tank for dispersing the gas into the liquid to form the mixed fluid.

9. The gas-liquid mixing control system of claim 1, wherein the fourth flow in the second end is equal to a requirement of the at least one machine to the mixed fluid.

10. The gas-liquid mixing control system of claim 9, wherein the non-electric control flow regulator is a mechanical valve which doesn't use electric power.

11. The gas-liquid mixing control system of claim 10, wherein the mechanical valve comprises a back pressure valve which has a preset threshold; when the at least one machine is closed, the fourth flow of the mixed fluid in the second end is 0, and the pressure of the mixed fluid in the output pipe and the mixing tank are higher than the preset threshold of the back pressure valve, so that the fifth flow of the mixed fluid is discharged through the back pressure valve; when the at least one machine is opened, the mixed fluid in the second end is provided with the fourth flow, and the pressure of the mixed fluid in the mixing tank is dispersed to the second end of the output pipe and the back pressure valve; if the pressure of the mixed fluid flowing to the back pressure valve is higher than or equal to the preset threshold of the back pressure valve, the mixed fluid would be discharged through the back pressure valve, and the fifth flow would be reduced; if the pressure of the mixed fluid flowing to the back pressure valve is lower than the preset threshold of the back pressure valve, the fifth flow of the mixed fluid would be 0, which could not be discharged through the back pressure valve.

12. A control method for gas-liquid mixing, comprising the steps of:
providing a liquid with a first constant pressure and a first flow into a mixing tank;
providing a gas with a second constant pressure and a second flow into the mixing tank, wherein the second constant pressure of the gas is higher than the first constant pressure of the liquid;
mixing the liquid and the gas in the mixing tank to form a mixed fluid; and
outputting the mixed fluid from the mixing tank to at least one machine through an output pipe, wherein the pressure of the mixed fluid in the mixing tank and the output pipe are the same; a first end of the output pipe communicates with the mixing tank, and a second end of the output pipe communicates with the at least one machine; the mixed fluid in the first end is provided with a third flow, and the mixed fluid in the second end is provided with a fourth flow; the output pipe communicates with a non-electric control flow regulator, and the mixed fluid passing through the non-electric control flow regulator is provided with a fifth flow;
wherein the first flow is greater than or equal to at least one of the fourth flow and the fifth flow.

13. The control method of claim 12, wherein the third flow is a fixed value; if the third flow is greater than the fourth flow, a difference between the third flow and the fourth flow is discharged by the non-electric control flow regulator.

14. The control method of claim 13, wherein the difference between the third flow and the fourth flow is equal to the fifth flow.

15. The control method of claim 12, wherein the mixing tank comprises a gas dispersion device located within the mixing tank for dispersing the gas into the liquid to form the mixed fluid.

16. The control method of claim 12, wherein the first flow is greater than or equal to 1000 times the second flow; the third flow is approximately equal to the first flow.

17. The control method of claim 12, further comprising a gas flowmeter provided between the gas supply unit and the mixing tank; the gas flowmeter communicates with the gas supply unit and the mixing tank for measuring and controlling the second flow of the gas, which makes the mixed fluid be within a preset range of conductivity.

18. The control method of claim 12, wherein the fourth flow in the second end is equal to a requirement of the at least one machine to the mixed fluid.

19. The control method of claim 18, wherein the non-electric control flow regulator is a mechanical valve which doesn't use electric power.

20. The control method of claim 19, wherein the mechanical valve comprises a back pressure valve which has a preset threshold; when the at least one machine is closed, the fourth flow of the mixed fluid in the second end is 0, and the pressure of the mixed fluid in the output pipe and the mixing tank are higher than the preset threshold of the back pressure valve, so that the fifth flow of the mixed fluid is discharged through the back pressure valve; when the at least one machine is opened, the mixed fluid in the second end is provided with the fourth flow, and the pressure of the mixed fluid in the output pipe and the mixing tank are reduces; if the pressure of the mixed fluid in the output pipe and the mixing tank is higher than or equal to the preset threshold of the back pressure valve, the fifth flow of the mixed fluid would be discharged through the back pressure valve, and the fifth flow would be reduced; if the pressure of the mixed fluid in the output pipe and the mixing tank are lower than the preset threshold of the back pressure valve, the fifth flow of the mixed fluid would be 0, which could not be discharged through the back pressure valve.
